(19) United States
(12) Patent Application Publication
(10) Pub. No.: US 2026/0356369 A1
(43) Pub. Date: Nov. 12, 2026

(54) Method for Providing Lane Change Assistance for Vehicles, and Lane Change Assistance Method for a Vehicle

(71) Applicant: Bayerische Motoren Werke Aktiengesellschaft, Muenchen (DE)

(72) Inventors: Felix REMPE, Dachau (DE); Jakob REUTER, Muenchen (DE)

(21) Appl. No.: 19/515,121

(22) PCT Filed: Aug. 14, 2024
(86) PCT No.: PCT/EP2024/072885

§ 371 Date: Feb. 27, 2026

(30) Foreign Application Priority Data
Aug. 31, 2023 (DE) 10 2023 123 547.8

(51) Int. Cl. B60W 30/18; B60W 40/08; B60W 50/00; B60W 50/14

(52) U.S. Cl. CPC B60W 30/18163; B60W 40/08; B60W 50/14; B60W 2040/0818; B60W 2050/0028; B60W 2050/143; B60W 2050/146; B60W 2520/105; B60W 2540/229; B60W 2554/4042; B60W 2554/4046; B60W 2554/80; B60W 2555/20; B60W 2556/40; B60W 2556/50

(57) ABSTRACT

A method provides lane change assistance for vehicles, by providing driving data of a vehicle, wherein the driving data relates to a first driving situation of the vehicle; performing a simulation of a second driving situation based on the driving data of the first driving situation to generate simulation data, wherein the first driving situation comprises at least one lane change and the second driving situation does not comprise a lane change, or wherein the second driving situation comprises at least one lane change and the first driving situation does not comprise a lane change; and training a lane change algorithm based on the driving data and/or the simulation data.

### BACKGROUND AND SUMMARY

The present disclosure relates to a method for providing lane change assistance for vehicles, a lane change assistance method for a vehicle, and a system for performing the methods. In particular, the present disclosure relates to calculating and initiating optimal lane changes, for example during automated driving.

Driver assistance systems for automated driving are becoming increasingly important. Automated driving can be achieved with varying degrees of automation. Examples of degrees of automation include assisted, semi-automated, conditionally automated, highly automated, and fully automated driving. The five degrees of automation mentioned above correspond to SAE Levels 1 to 5 of the SAE J3016 standard (SAE—Society of Automotive Engineering) as of Apr. 30, 2021. In fully automated driving (SAE Level 5), the system can perform all aspects of the dynamic driving task under any road and environmental conditions that a human driver can handle.

Modern vehicles are increasingly equipped with lane change assistants. Depending on the degree of automation, the driver can change lanes themselves or trigger an automated lane change, or the vehicle can change lanes completely automatically. In at least some of these cases, the vehicle can perform automated lane change planning, wherein the vehicle checks, for example, whether there is sufficient space, whether a lane change is necessary according to the navigation system in order to remain on the planned route, whether the vehicle is being slowed down in the current lane by a slower vehicle in front, etc.

Lane changes are generally associated with an increased safety risk, as collisions with other vehicles are more likely compared to remaining in the current lane. With lane change assistance according to SAE Level 2, the driver must monitor the function, which puts the driver on high alert, reducing driving comfort. Similarly, driving comfort may be reduced due to too many lane changes that must be monitored by the driver. This may cause the driver to deactivate the function. Deactivating lane change assistance can have a negative impact on road safety, as lane change assistance often offers greater safety compared to manual driving. In addition, too many or too few lane changes can have a negative impact on the vehicle's travel time and/or traffic flow.

One object of the present disclosure is to provide a method for providing lane change assistance for vehicles, a lane change assistance method for a vehicle, and a system for executing the aforementioned methods, which enable a reliable assessment in advance of whether or not a lane change is appropriate in a current situation. In addition, it is an object of the present disclosure to maximize the useful life of a lane change assistance system and thus increase road safety.

This object is achieved by the subject matter of the independent claims. Advantageous embodiments are specified in the dependent claims.

According to an independent aspect of the present disclosure, a method for providing lane change assistance for vehicles, in particular motor vehicles, is specified. The method comprises providing driving data of a vehicle, wherein the driving data relates to a first driving situation of the vehicle; performing a simulation of a second driving situation based on the driving data of the first driving situation to generate simulation data, wherein the first driving situation comprises at least one lane change and the second driving situation does not comprise a lane change, or wherein the second driving situation comprises at least one lane change and the first driving situation does not comprise a lane change; and training a lane change algorithm based on the driving data and/or the simulation data.

According to the invention, a data-driven approach is used to train a lane change algorithm that can determine whether or not a lane change is advantageous in a current situation. For this purpose, real journeys, e.g., of a fleet of vehicles, are evaluated. In particular, a real journey involving a lane change is simulated without a lane change, or a real journey without a lane change is simulated with a lane change. Based on a comparison of the real and simulated driving situations with and without lane changes, it can then be determined whether the lane change is advantageous or not. The lane change algorithm trained based on these findings can then be implemented in real vehicles and enable a reliable assessment in real operation as to whether a lane change is advisable in a current situation or not.

The lane change algorithm is trained based on the driving data and/or the simulation data. In some embodiments, the lane change algorithm can be trained using (only) the data that corresponds to the better alternative. In other embodiments, the lane change algorithm can be trained using both the driving data from real operation and the simulation data.

Preferably, performing the simulation of the second driving situation comprises determining a driving behavior of the vehicle and determining a driving behavior of at least one other vehicle. In particular, a change in the driving behavior of the vehicle and a change in the driving behavior of the at least one other vehicle can be determined with respect to the addition or omission of the lane change. This makes it possible to determine and analyze the driving behaviors in both situations, i.e., once with a lane change and once without a lane change.

Preferably, the method further comprises performing a comparison of the first driving situation and the second driving situation (or corresponding driving situation-related data); and determining, based on the comparison, whether the at least one lane change is favorable or unfavorable. The terms “favorable” and “unfavorable” refer to objective criteria that indicate which of the driving situations is more efficient and/or advantageous.

Preferably, the comparison is performed with respect to the first driving situation and the second driving situation based on at least one comparison criterion. The at least one comparison criterion is an objective criterion that indicates which of the driving situations is more favorable or advantageous. This allows the first driving situation and the second driving situation to be objectively compared and thus evaluated.

In some embodiments, the at least one comparison criterion is selected from the group comprising (or consisting of) the following:
a travel time difference; and/or
a speed difference to at least one other vehicle; and/or
a distance to at least one other vehicle; and/or
a difference in driver attention; and/or
energy consumption of the vehicle; and/or
acceleration behavior of the vehicle and/or at least one other vehicle.

With regard to the travel time difference, it can be determined, for example, whether a destination can be reached faster with or without changing lanes. The driving situation with the shorter travel time can then be classified as the favorable driving situation.

With regard to the speed difference to at least one other vehicle, it can be determined, for example, how great the speed difference is to another vehicle driving in front of the vehicle or the vehicle in front. If the speed difference is large and the ego vehicle is faster than the vehicle in front, changing lanes to overtake the vehicle in front may be more favorable than not changing lanes or remaining behind the vehicle in front. If, on the other hand, the speed difference is small and the ego vehicle is faster than the vehicle in front, changing lanes to overtake the vehicle in front may be less favorable than not changing lanes or remaining behind the vehicle in front due to only a minimal reduction in travel time and an increased risk of collision as a result of the lane change.

With regard to the distance to at least one other vehicle, it is possible, for example, to determine how great the distance is to another vehicle or the vehicle in front. If the distance is large and the ego vehicle is only minimally faster than the vehicle in front, changing lanes to overtake the vehicle in front may be less favorable than not changing lanes or remaining behind the vehicle in front due to only a minimal reduction in travel time and an increased risk of collision caused by the lane change.

With regard to the difference in driver attention, a required level of driver attention can be determined in both driving situations, wherein the driving situation involving a lane change often requires a higher level of driver attention than a driving situation without a lane change. If the difference in attention is large, not changing lanes may be more favorable than changing lanes. In particular, the large difference in attention can be associated with a greatly increased risk of accidents, so that it may be more favorable to refrain from changing lanes.

With regard to the energy consumption (e.g., fuel and/or electrical energy) of the vehicle, it is possible to determine how high the energy consumption is in both driving situations and/or how large the difference in energy consumption is. The driving situation with the lower energy consumption can be classified as the favorable driving situation.

With regard to the acceleration behavior of the vehicle and/or at least one other vehicle, it can be determined, for example, whether the acceleration behavior present in both driving situations is to be evaluated positively or negatively. For example, it may be necessary for the ego vehicle to accelerate strongly in order to overtake a vehicle in front. In this case, changing lanes to overtake the vehicle in front may be less favorable than not changing lanes or remaining behind the vehicle in front due to the increased risk of collision caused by the lane change. In another example, it may be necessary for the ego vehicle to brake heavily without changing lanes in order to avoid colliding with a vehicle in front. In this case, changing lanes to overtake the vehicle in front may be more favorable than not changing lanes or remaining behind the vehicle in front.

In some embodiments, the driving data of the first or real driving situation is selected from the group comprising (or consisting of) the following:

position data of the vehicle; and/or
dynamic data of the vehicle, in particular speed data; and/or
environmental data from an environmental sensor system of the vehicle; and/or
operating data of the vehicle; and/or
driving maneuver data of the vehicle.

With regard to the position data of the vehicle, GPS positions from the first or real driving situation can be fed into the simulation, for example. The position data enable, for example, a determination of a driving path of the vehicle in the first or real driving situation.

With regard to the vehicle's dynamic data, variables describing the vehicle's movement from the initial or real driving situation can be fed into the simulation. The dynamic data may include, for example, speed data and/or acceleration data (e.g., longitudinal acceleration and/or lateral acceleration), but is not limited to this.

With regard to the environmental data from the vehicle's environmental sensors from the first or real driving situation, this data can be selectively and/or (pre-)processed (e.g., as detections) and fed into the simulation. Preferably, the environmental sensors comprise at least one LiDAR system and/or at least one radar system and/or at least one camera and/or at least one ultrasonic system. The environmental sensors can provide the environmental data (also referred to as “surrounding data”) that map an area surrounding the vehicle.

With regard to the operating data of the vehicle from the first or real driving situation, this can be fed into the simulation in order to map the behavior of the vehicle in the simulation as accurately as possible and to enable a correlation between the first or real driving situation and the second or simulated driving situation. The operating data of the vehicle may, for example, relate to the operation of a drive (e.g., combustion engine, electric drive, operating mode, etc.) and/or the operation of driver assistance systems and/or a vehicle condition (e.g., tire pressure), but is not limited to these examples.

With regard to the driving maneuver data of the vehicle from the first or real driving situation, this data can indicate which driving maneuvers the vehicle has performed. The driving maneuvers can relate, for example, to lane changes, steering maneuvers, braking maneuvers, acceleration maneuvers, etc., but are not limited to these examples.

Preferably, the simulation of the second driving situation is performed based on the driving data of the first driving situation and additional data.

In some embodiments, the additional data is selected from the group comprising (or consisting of) the following:
digital map data; and/or
third-party vehicle information (e.g., positions, speeds, vehicle types, etc.); and/or
dynamic traffic information (e.g., traffic jams, slow-moving traffic, etc.); and/or
environmental information (e.g., hazard warnings, roadworks, weather conditions, etc.); and/or
traffic infrastructure information (e.g., lanes, number of lanes, lane geometry, etc.).

Preferably, the method further comprises providing the trained lane change algorithm to a fleet of vehicles comprising a plurality of vehicles. In particular, the trained lane change algorithm can be installed in the vehicles of the vehicle fleet and used there in real-e operation to enable an assessment of whether a lane change is advisable in a current situation or not.

Preferably, the lane change algorithm comprises or is at least one neural network, in particular a trained neural network. Neural networks consist of a series of processing units connected to each other via communication channels, known as neurons. The neurons process input data and pass on the result of the processing to other neurons via the communication channels. The parallel processing of data, which is made possible by the interconnection of the neurons and their processing functions, allows complex, nonlinear dependencies in the input data to be mapped. Neural networks are trained using a suitable learning technique, e.g., machine learning, so that they can learn these dependencies. Neural networks can be trained using empirical data, known as training data.

Preferably, the lane change algorithm is a machine learning-based algorithm. Machine learning (ML) refers to the artificial generation of knowledge from experience. Here, algorithms learn from empirical data and, after completing the learning phase, are able to generalize the experiences. To do this, the algorithms build a statistical model based on the empirical data. The empirical data used to train the algorithms is generally referred to as “training data.”

According to a further independent aspect of the present disclosure, a system for providing lane change assistance for vehicles is disclosed. The system comprises one or more processors; and at least one memory connected to the one or more processors and containing instructions that can be executed by the one or more processors to perform the method described herein for providing lane change assistance for vehicles.

Preferably, the system comprises at least one server and/or at least one backend, or is implemented by the at least one server and/or the at least one backend.

A processor or processor module is a programmable computing unit, i.e., a machine or electronic circuit that controls other elements according to transmitted commands and thereby drives an algorithm (process).

According to a further independent aspect of the present disclosure, a lane change assistance method for a vehicle, in particular a motor vehicle, is specified. The lane change assistance method comprises determining, using a lane change algorithm trained with the method described in this document, whether or not a lane change should be performed in a current driving situation of the vehicle.

Preferably, the lane change assistance method further comprises issuing a corresponding recommendation to a driver of the vehicle and/or performing an automated lane change if it is determined that a lane change should be performed.

Preferably, the lane change assistance method further comprises determining at least one driving maneuver to be performed based on whether or not the lane change should be performed in the current driving situation of the vehicle. The at least one driving maneuver to be performed may relate to a driving maneuver other than the lane change or may be a driving maneuver other than the lane change, and may in particular be an additional driving maneuver. In some embodiments, the at least one driving maneuver to be performed may include an acceleration maneuver and/or a braking maneuver, but is not limited to these examples.

Preferably, the lane change assistance method further comprises issuing a corresponding recommendation with respect to the at least one driving maneuver to be performed to a driver of the vehicle and/or automatically performing the at least one driving maneuver.

According to a further independent aspect of the present disclosure, a driving assistance system for vehicles is provided. The driving assistance system comprises one or more processors; and at least one memory connected to the one or more processors and containing instructions that can be executed by the one or more processors to execute the lane change assistance method described in this document.

Preferably, the driving assistance system is designed for automated driving.

In the context of this document, the term “automated driving” refers to driving with automated longitudinal and/or lateral guidance. Automated driving can, for example, involve driving on the highway for a longer period of time or driving for a limited period of time when parking. The term “automated driving” covers automated driving with any degree of automation. Examples of degrees of automation are assisted, partially automated, conditionally automated, highly automated, and fully automated driving (with increasing degrees of automation in each case). The five levels of automation mentioned above correspond to SAE Levels 1 to 5 of the SAE J3016 standard (SAE—Society of Automotive Engineering) as of Apr. 30, 2021.

In assisted driving (SAE Level 1), the system performs longitudinal or lateral guidance in certain driving situations. In partially automated driving (SAE Level 2), the system takes over longitudinal and lateral guidance in certain driving situations, wherein the driver must continuously monitor the system as in assisted driving. In conditional automated driving (SAE Level 3), the system takes over longitudinal and lateral guidance in certain driving situations without the driver having to monitor the system continuously; however, the driver must be able to take over vehicle control at the system's request within a certain period of time. In highly automated driving (SAE Level 4), the system takes over vehicle control in certain driving situations, even if the driver does not respond to a request to intervene, so that the driver is no longer needed as a fallback. In fully automated driving (SAE Level 5), the system can perform all aspects of the dynamic driving task under any road and environmental conditions that a human driver can handle.

In addition, the term “at least partially automated driving or maneuvering” in the context of this document is also understood to mean partially automated, conditionally automated, highly automated, and fully automated driving. In other words, the term “at least partially automated driving” is understood to mean a degree of automation from SAE Level 2 onwards.

Preferably, the driver assistance system includes or is a lane change assistant that is set up to perform automated lane changes.

However, the embodiments of the present disclosure are not limited to automated driving or automated lane changes. In alternative embodiments, the driver assistance system may use at least one output device to provide driver instructions when the vehicle is being driven manually. The driver instruction may, for example, be a recommendation as to whether or not a lane change should be performed in the vehicle's current driving situation.

The at least one output device may comprise at least one display device and/or at least one loudspeaker. The at least one display device may comprise a display, in particular an LCD display, a plasma display, or an OLED display. In addition or alternatively, the at least one display device may comprise a projection device that is set up to display information directly in the driver's field of vision, in particular to project onto a windshield. In some embodiments, the at least one display device may be a central information output device of an infotainment system, such as a head unit or a pillar-to-pillar display. Preferably, the at least one output device is permanently installed in the vehicle.

According to another independent aspect of the present disclosure, a vehicle, in particular a motor vehicle, is specified. The vehicle comprises the driver assistance system according to the embodiments of the present disclosure.

The term “vehicle” encompasses passenger cars, trucks, vans, buses, motor homes, motorcycles, etc., which are used to transport people, goods, etc. In particular, the term encompasses motor vehicles for transporting people.

According to a further independent aspect of the present disclosure, a software (SW) program is specified. The SW program can be set up to run on one or more processors and thereby execute the methods described in this document.

According to a further independent aspect of the present disclosure, a storage medium is specified. The storage medium may comprise a SW program that is set up to run on one or more processors and thereby execute the methods described in this document.

According to a further independent aspect of the present disclosure, a software program code is provided. The software program code is configured to perform the methods described herein when the software program code runs on one or more software-controlled devices.

Exemplary embodiments of the disclosure are shown in the figures and are described in more detail below.

### BRIEF DESCRIPTION OF THE DRAWINGS

FIG. 1 is a flowchart of a method for providing lane change assistance for vehicles according to embodiments of the present disclosure;

FIG. 2 shows a system for providing lane change assistance for vehicles according to embodiments of the present disclosure;

FIG. 3 is a flowchart of a lane change assistance method according to embodiments of the present disclosure; and

FIG. 4 schematically shows a vehicle with a driver assistance system for automated driving according to embodiments of the present disclosure.

Unless otherwise noted, the same reference numerals are used for identical and similarly functioning elements.

### DETAILED DESCRIPTION OF THE DRAWINGS

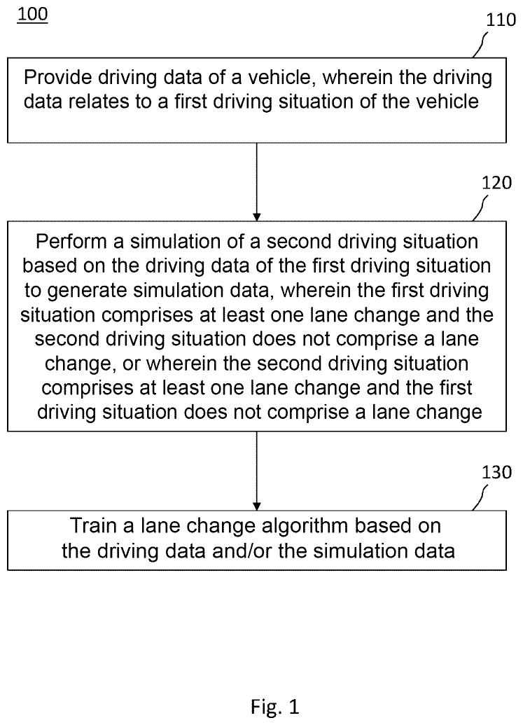

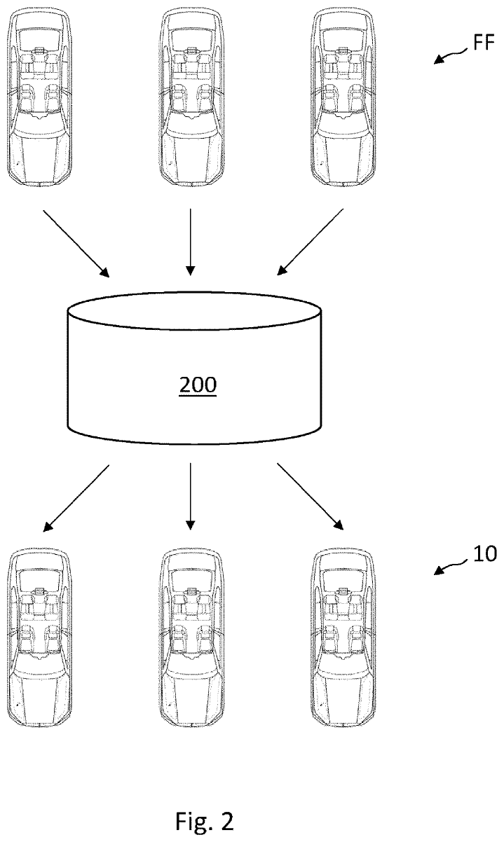

FIG. 1 schematically shows a flowchart of a method 100 for providing lane change assistance for vehicles according to embodiments of the present disclosure. FIG. 2 shows a system for providing lane change assistance for vehicles according to embodiments of the present disclosure. In particular, the system may comprise a central unit 200 that is set up to execute the method 100. The central unit 200 may be a server or backend.

The method 100 comprises, in block 110, providing driving data of a vehicle, wherein the driving data relates to a first driving situation of the vehicle; in block 120, performing a simulation of a second driving situation based on the driving data of the first driving situation to generate simulation data, wherein the first driving situation comprises at least one lane change and the second driving situation does not comprise a lane change, or wherein the second driving situation comprises at least one lane change and the first driving situation does not comprise a lane change; and in block 130, training a lane change algorithm based on the driving data and/or the simulation data.

According to the invention, a data-driven approach is used to train a lane change algorithm that can determine whether or not a lane change is advantageous in a current situation. For this purpose, real journeys, e.g., of a vehicle fleet FF, are evaluated. In particular, a real journey with a lane change is simulated with a corresponding journey without a lane change, or a real journey without a lane change is simulated with a corresponding journey with a lane change. Based on a comparison of the real and simulated driving situations with and without lane changes, it can then be determined whether the lane change is advantageous or not. The lane change algorithm trained based on these findings can then be implemented in real vehicles and enable a reliable assessment in real operation as to whether a lane change is advisable in a current situation or not.

In detail, large amounts of data on real journeys made by the vehicle fleet FF are collected and evaluated in the backend. The result of the evaluation is whether a lane change was advantageous at a specific point in time t during this journey or whether it would have been better for the vehicle to remain in the current lane at that point in time.

For each decision point t, both options are calculated and compared. In addition to the real driving situation, a possible implementation is also simulated. This simulation is fed with data from the vehicle, a digital map, dynamic traffic information, and/or environmental information. Examples of such input data include, but are not limited to, positions, speeds, and/or types of other vehicles in space and time; a current lane, route, number of lanes, and lane geometries in the current and following route section; traffic information, hazard warnings, and/or roadworks.

The behavior of other vehicles can be predicted using modern microsimulation if not available in the data. The behavior of the ego vehicle is recalculated and predicted based on the control software in the ego vehicle. The comparison of the implementation variants at time t can include the difference in travel time, the speed differences to other vehicles, the distances to other vehicles, the additional driver attention required, the fuel/energy consumption, the differences in the acceleration values of all vehicles, etc.

The data set prepared in this way can be used to train an ML model that calculates whether a lane change is advisable at the current time or at a future time, depending on the current situation of the vehicle in relation to an environment model, a position, a selected route, etc. This model is transferred to the vehicle fleet and runs on the control units in the vehicles.

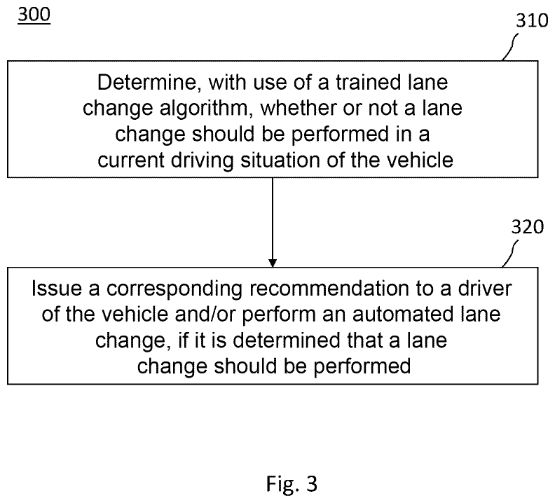

FIG. 3 shows a flowchart of a lane change assistance method 300 according to embodiments of the present disclosure.

The lane change assistance method 300 comprises, in block 310, determining, using a lane change algorithm trained with the method described in this document, whether or not a lane change should be performed in a current driving situation of the vehicle; and, in block 320, issuing a corresponding recommendation to a driver of the vehicle and/or performing an automated lane change if it is determined that a lane change should be performed.

In some embodiments, a probability indicating the advisability of the lane change may also be calculated. In addition or alternatively, an additional maneuver, e.g., braking or accelerating, may be associated with the lane change. In addition or alternatively, the lane change can be offered to the driver as a suggestion, which the driver must first agree to. In addition or alternatively, the method can be personalized by asking the driver to provide feedback after a lane change as to whether the lane change was perceived as positive or negative. This feedback can then be incorporated into the training of the algorithm.

In an illustrative example, an ego vehicle with Level 3 functionality is driving in automatic mode at 130 km/h in the right lane of a two-lane highway. A convoy of trucks traveling at a speed of 80 km/h appears in front of the ego vehicle. Traffic is heavy, and the vehicle is scheduled to leave the highway in two kilometers. It might be possible to save travel time by changing lanes, overtaking the trucks, and then rejoining them. However, the system, which has been trained for similar situations, does not recommend overtaking because in similar situations it has been impossible to merge back into the right lane due to heavy traffic, resulting in the exit being missed.

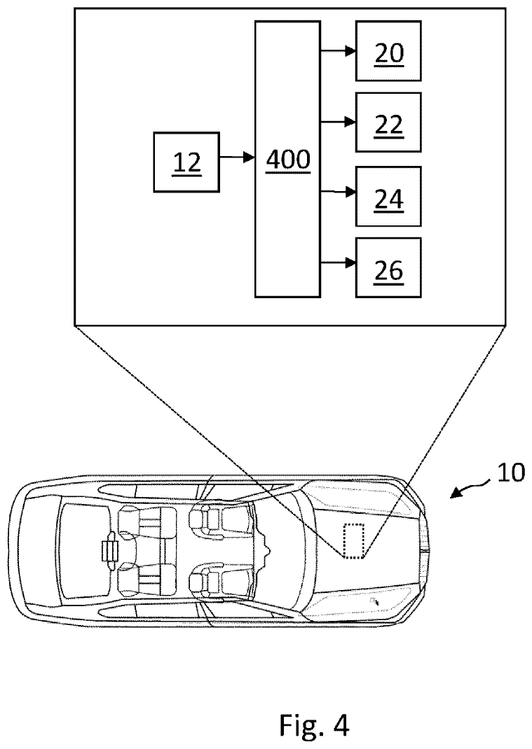

FIG. 4 schematically shows a vehicle 10 with a driver assistance system 400 for automated driving according to embodiments of the present disclosure.

The driver assistance system 400 comprises a lane change assistant or is a lane change assistant or can implement the functionalities of a lane change assistant. In particular, the driver assistance system 400 can use the lane change algorithm trained with the method described in this document to determine whether or not a lane change should be performed in a current driving situation of the vehicle 10. If it is determined that the lane change should be performed, the driver assistance system 400 can perform the lane change automatically.

In automated driving according to the embodiments of the present disclosure, the lateral guidance (and optionally the longitudinal guidance) of the vehicle 10 is performed automatically. The driver assistance system 400 thus takes over the vehicle guidance. To this end, the driver assistance system 400 controls the steering 26 and, optionally, the drive 20, the transmission 22, and the service brake 24 via intermediate units not shown.

For the planning and execution of automated driving, environmental information from environmental sensors that observe the vehicle environment is received by the driver assistance system 400. In particular, the vehicle 10 may comprise at least one environmental sensor 12 that is set up to record environmental data that indicates the vehicle environment. The at least one environmental sensor 12 may, for example, comprise one or more LiDAR systems, one or more radar systems, one or more ultrasonic sensors, and/or one or more cameras.

In some embodiments, the driver assistance system 400 comprises an actuator for a direction indicator, wherein the actuator may be arranged to automatically perform a lane change when actuated or triggered by a driver. The actuator may be a turn signal lever and have a multiple function, namely activating the direction indicator and triggering the lane change. In other embodiments, the driver assistance system 400 may perform the lane change autonomously without any action on the part of the driver.

However, the embodiments of the present disclosure are not limited to automated driving. In alternative embodiments, the driver assistance system may use at least one output device to provide driver instructions regarding lane changes when the vehicle is being driven manually. The driver instructions can provide the driver with information about lane changes, for example, whether they are possible, impossible, safe, dangerous, advantageous, etc. For example, the driver assistance system 400 can suggest a lane change if the lane change algorithm determines that it is favorable or advantageous.

The at least one output device may comprise at least one display device and/or at least one loudspeaker. The at least one display device may comprise a display, in particular an LCD display, a plasma display, or an OLED display. In addition or alternatively, the at least one display device may comprise a projection device that is set up to display information directly in the driver's field of vision, in particular to project onto a windshield. In some embodiments, the at least one display device may be a central information output device of an infotainment system, such as a head unit or a pillar-to-pillar display. Preferably, the at least one output device is permanently installed in the vehicle.

Although the invention has been illustrated and explained in detail by preferred exemplary embodiments, the invention is not limited by the disclosed examples, and other variations can be derived from them by those skilled in the art without departing from the scope of protection of the invention. It is therefore clear that a multitude of variations are possible. It is also clear that the embodiments mentioned as examples are really only examples and should not be construed in any way as limiting the scope of protection, the possible applications, or the configuration of the invention. Rather, the preceding description and the description of the figures enable the skilled person to implement the exemplary embodiments in concrete terms, wherein the skilled person, knowing the disclosed inventive concept, can make a variety of changes, for example with regard to the function or arrangement of individual elements mentioned in an exemplary embodiment, without leaving the scope of protection defined by the claims and their legal equivalents, such as further explanations in the description.

1-10. (canceled)

11. A method for providing lane change assistance for vehicles, comprising:
providing driving data of a vehicle, wherein the driving data relates to a first driving situation of the vehicle;
performing a simulation of a second driving situation based on the driving data of the first driving situation to generate simulation data, wherein the first driving situation comprises at least one lane change and the second driving situation does not comprise a lane change, or wherein the second driving situation comprises at least one lane change and the first driving situation does not comprise a lane change; and
training a lane change algorithm based on the driving data and/or the simulation data.

12. The method according to claim 11, wherein performing the simulation of the second driving situation comprises:
determining a driving behavior of the vehicle and determining a driving behavior of at least one foreign vehicle.

13. The method according to claim 11, further comprising:
performing a comparison of the first driving situation and the second driving situation; and
determining, based on the comparison, whether the at least one lane change is favorable or unfavorable.

14. The method according to claim 13, wherein performing the comparison of the first driving situation and the second driving situation is based on at least one comparison criterion, wherein the at least one comparison criterion comprises at least one of:
a travel time difference;
a speed difference to at least one other vehicle;
a distance to at least one other vehicle;
a difference in driver attention;
energy consumption of the vehicle; or
acceleration behavior of the vehicle and/or at least one other vehicle.

15. The method according to claim 11, wherein the driving data comprises at least one of:
position data of the vehicle;
dynamic data of the vehicle,
environmental data from an environmental sensor system of the vehicle;
operating data of the vehicle; or
driving maneuver data of the vehicle.

16. The method according to claim 11, wherein the simulation of the second driving situation is performed based on the driving data of the first driving situation and additional data, wherein the additional data comprises at least one of:
digital map data;
information about other vehicles;
dynamic traffic information;
environmental information; or
traffic infrastructure information.

17. The method according to claim 11, further comprising:
providing the trained lane change algorithm to a vehicle fleet comprising a plurality of vehicles.

18. A lane change assistance method for a vehicle, comprising:
determining, using a lane change algorithm trained with the method according to claim 11, whether or not a lane change should be performed in a current driving situation of the vehicle; and
issuing a corresponding recommendation to a driver of the vehicle and/or performing an automated lane change when it is determined that a lane change should be performed.

19. The lane change assistance method according to claim 18, further comprising:
determining at least one driving maneuver to be performed based on whether or not the lane change should be performed in the current driving situation of the vehicle, wherein the at least one driving maneuver to be performed relates to a driving maneuver other than the lane change; and
issuing a corresponding recommendation with regard to the at least one driving maneuver to be performed to a driver of the vehicle and/or automatically performing the at least one driving maneuver to be performed.

20. A system, comprising:
one or more processors; and
at least one memory connected to the one or more processors, and storing instructions executable by the one or more processors, to carry out the acts of:
providing driving data of a vehicle, wherein the driving data relates to a first driving situation of the vehicle;
performing a simulation of a second driving situation based on the driving data of the first driving situation to generate simulation data, wherein the first driving situation comprises at least one lane change and the second driving situation does not comprise a lane change, or wherein the second driving situation comprises at least one lane change and the first driving situation does not comprise a lane change; and
training a lane change algorithm based on the driving data and/or the simulation data.
